(19) United States
(12) Patent Application Publication
(10) Pub. No.: US 2010/0172532 A1
(43) Pub. Date: Jul. 8, 2010

(54) EARPHONE AND HEADSET

(75) Inventors: Oliver Gelhard, Hannover (DE); Christian Grone, Neustadt (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co. KG, Wedemark (DE)

(21) Appl. No.: 12/637,014

(22) Filed: Dec. 14, 2009

(30) Foreign Application Priority Data
Dec. 15, 2008 (DE) 10 2008 061 844.6

(51) Int. Cl. H04R 25/00

(52) U.S. Cl. 381/375

(57) ABSTRACT

There is provided an earphone comprising a first housing (2) with a first control unit (30), a first electroacoustic reproduction transducer (W1, a first operating element (20) and a first microphone (40) for recording speech signals (SS). The first control unit (30) is electrically connected to the first operating element (20), the first microphone (40) and the first electroacoustic reproduction transducer (W1). The control unit receives an audio signal (AS) to be reproduced and in a first mode of operation the control unit outputs that signal for reproduction to the first electroacoustic reproduction transducer (W1). The earphone further has a second housing (3) with a second control unit (50) and a second electroacoustic reproduction transducer (W2). The second control unit (50) receives an audio signal (AS) to be reproduced and outputs that audio signal to the second electroacoustic reproduction transducer (W2). At least the first control unit (30) is switched into a second mode of operation upon actuation of the first operating element (20) and the speech signal recorded by the first microphone (40) is reproduced by way of the first electroacoustic reproduction transducer (W1). Reproduction of the audio signal (AS) to be reproduced is at least partially damped.

The present invention concerns an earphone and a headset.

In relation to earphones or headsets which are used in a noisy environment difficulties in understanding can occur, for example if the earphone or the headset has active and/or passive noise reduction.

Thus an object of the present invention is to provide an earphone and a headset which permit improved intelligibility in a noisy environment.

That object is attained by an earphone as set forth in claim 1 and by a headset as set forth in claim 4.

Thus there is provided an earphone comprising a first housing, a first control unit, a first electroacoustic reproduction transducer, a first operating element and a first microphone for recording speech signals. The first control unit is electrically connected to the first operating element, the first microphone and the first electroacoustic reproduction transducer. The control unit receives an audio signal to be reproduced and in a first mode of operation the control unit outputs that signal for reproduction to the first electroacoustic reproduction transducer. The earphone further has a second housing with a second control unit and a second electroacoustic reproduction transducer. The second control unit receives an audio signal to be reproduced and outputs that audio signal to the second electroacoustic reproduction transducer. At least the first control unit is switched into a second mode of operation upon actuation of the first operating element and the speech signal recorded by the first microphone is reproduced by way of the first electroacoustic reproduction transducer. Reproduction of the audio signal to be reproduced is at least partially damped.

In accordance with an aspect of the invention the first control unit has a first active noise reduction unit and the second control unit has a second active noise reduction unit for respective active noise reduction.

In addition there is provided a headset comprising a first housing, a first control unit, a first electroacoustic reproduction transducer, a first operating element and a first microphone for recording speech signals. The first control unit is electrically connected to the first operating element, the first microphone and the first electroacoustic reproduction transducer. The control unit receives an audio signal to be reproduced and in a first mode of operation the control unit outputs that signal for reproduction to the first electroacoustic reproduction transducer. The headset further has a second housing with a second control unit and a second electroacoustic reproduction transducer. The second control unit receives an audio signal to be reproduced and outputs that audio signal to the second electroacoustic reproduction transducer. At least the first control unit is switched into a second mode of operation upon actuation of the first operating element and the speech signal recorded by the first microphone is reproduced by way of the first electroacoustic reproduction transducer. Reproduction of the audio signal to be reproduced is at least partially damped.

In accordance with an aspect of the invention the first control unit has a first active noise reduction unit and the second control unit has a second active noise reduction unit for respective active noise reduction.

The invention concerns the notion of operating an earphone or a headset in at least two modes of operation. In a first mode a key or button or an operating element externally on the earphone or the headset (or a cable of the earphone or the headset) is not pressed or activated and reproduction of an audio signal to be reproduced is effected by way of the two electroacoustic reproduction transducers of the earphone or the headset. In the first mode of operation a first microphone for recording speech signals is not switched on. In a second mode of operation the key or button or the operating element is pressed or activated and reproduction of the audio signals to be reproduced is effected at reduced volume or only by way of one of the electroacoustic reproduction transducers. In addition the external microphone is activated and the audio signals recorded by way of the microphone can be reproduced by one of the electroacoustic reproduction transducers.

The level of reproduction of the audio signal to be reproduced can be reduced at one reproduction transducer and also reduced or completely switched off at the other reproduction transducer.

Further configurations of the invention are subject-matter of the appendant claims.

Advantages and embodiments by way of example of the invention are described in greater detail hereinafter with reference to the drawing.

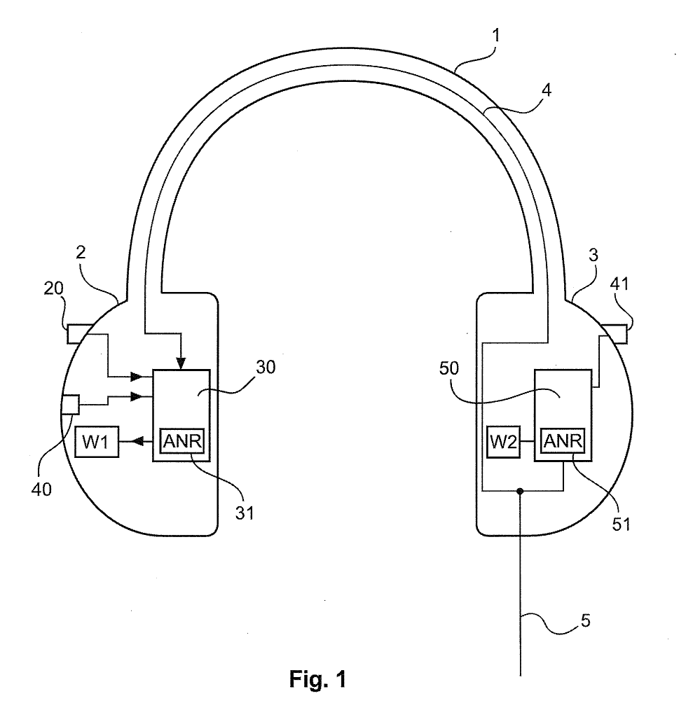

FIG. 1 shows a diagrammatic view of an earphone or a headset in accordance with a first embodiment.

FIG. 1 shows a diagrammatic view of an earphone or a headset in accordance with a first embodiment. The earphone or headset 1 has first and second housings 2, 3 which have respective first and second electroacoustic reproduction transducers W1, W2. The first and second electroacoustic reproduction transducers W1, W2 serve to reproduce an audio signal AS received for example by way of a cable 5. Provided in the first housing 2, besides the first electroacoustic transducer W1, there are a first control unit 30, an operating element 20 externally on the housing and a first microphone 40 for recording speech signals SS. The first control unit 30 is electrically connected to the operating element 20, the first microphone 40 and the first electroacoustic reproduction transducer W1.

The first control unit 30 is further connected for example by way of an electric line 4 to the outside cable 5 and thereby can receive an audio signal AS to be reproduced.

The second electroacoustic reproduction transducer W2 and a second control unit 50 are provided in the second housing 3. The second housing 3 can optionally have a second microphone 41 for recording speech signals SS. The first control unit 30 can have an active noise reduction unit ANR 31. The second control unit 50 can have an active noise reduction unit ANR 51. The second control unit 50 is electrically connected to the reproduction transducer W2, optionally to the second microphone 41 and to the outside cable 5 in order thereby to receive an audio signal AS to reproduced.

Upon actuation of the operating element 20, for example a key or button or a switch, the earphone or the headset can be switched over from a first mode of operation into a second mode. In the first mode of operation the operating element is not actuated and an audio signal AS to be reproduced, which is received by way of the outside cable 5, is received by the first and second control units 30, 50 and reproduced at the first and second electroacoustic reproduction transducers W1, W2. If the first and second control units 30, 50 each have a respective active noise reduction unit 31, 51, active noise reduction can be implemented and a noise-reduced audio signal can be outputted at the first and second electroacoustic reproduction transducers W1, W2.

In the second mode of operation, that is to say when the operating element is actuated, the first microphone 40 is activated and the speech signals SS recorded by the microphone are outputted to the first control unit 30. The first control unit 30 passes those recorded speech signals SS to the first electroacoustic reproduction transducer W1 for reproduction thereof. In addition the first control unit 30 can damp the audio signal AS received through the cables 4, 5 or completely damp same (that is to say at least partially reduce the volume level of the audio signal) so that the signal SS from the first microphone 40 and optionally the damped audio signal is reproduced by way of the first electroacoustic reproduction transducer W1. Optionally, filtering of the speech signal recorded by the microphone 40 can be effected in the first control unit 30 to improve the speech intelligibility of the speech signal.

In the second mode of operation the second control unit 50 can be adapted to output the audio signal AS to be reproduced, in unaltered form, to the second electroacoustic reproduction transducer W2. As an alternative thereto the audio signal to be reproduced can be reproduced in damped form by the second electroacoustic reproduction transducer W2.

In accordance with the invention the first and second electroacoustic reproduction transducers W1, W2, upon actuation of the operating element 20, can be controlled in such a way that the audio signal AS to be reproduced is reproduced at different volume levels.

Single-sided suppression or damping of an audio signal AS to be reproduced means that the speech intelligibility can be improved for example on the side of the first housing 2 in terms of the talk-through functionality.

In accordance with an aspect of the present invention the first and second active noise reduction units ANR 31, 51 can be activated or remain activated when the second mode of operation is activated. It is thus possible to suppress predominantly low-frequency noise by active noise reduction so that speech intelligibility can also be improved.

By means of the operating element 20 it is also possible to select whether the audio signal to be reproduced is entirely, partially or not suppressed.

By means of the operating element 20 it is also optionally possible to control the side on which reproduction of the audio signal is damped or switched off.

With a headset according to the invention it is possible to electronically simulate a situation which occurs in relation to pilots. If for example a pilot would like to talk to the co-pilot, headsets are known in which an earpiece can be pivoted upwardly to expose an ear. The pilot can understand the co-pilot through his exposed ear while the signals from the control tower can be heard at the other ear which is covered by a further earpiece.

In accordance with the invention it is possible electronically to simulate pivoting the earphone earpiece up at one side. In the case of a headset according to the invention an operating element or a key or button can be provided for example externally on an earpiece. Actuation of the key or button provides for activation of a talk-through functionality, that is to say a microphone on the earpiece is activated and the speech signals recorded by that microphone are reproduced by way of an electroacoustic reproduction transducer. At the same time the signal received for example from the control tower can be damped or switched off upon reproduction in that earpiece. Thus for example a pilot can still receive the control tower signal by way of the other earpiece.

In accordance with a further embodiment of the invention there can be provided only one active noise reduction unit ANR instead of the first and second active noise reduction units ANR. It is thus possible to save on one of the active noise reduction units. In this embodiment then there is a single active noise reduction unit which effects active noise reduction both for the right transducer and also for the left transducer.

1. An earphone comprising:
a first housing with a first control unit, a first electroacoustic reproduction transducer, a first operating element and a first microphone for recording speech signals,
wherein the first control unit is electrically connected to the first operating element, the first microphone and the first electroacoustic reproduction transducer and receives an audio signal to be reproduced and outputs same in a first operating mode to the first electroacoustic reproduction transducer for reproduction, and
a second housing with a second control unit and a second electroacoustic reproduction transducer, wherein the second control unit receives an audio signal to be reproduced and outputs the audio signal for reproduction to the second electroacoustic reproduction transducer,
characterised in that at least the first control unit is switched into a second mode of operation upon actuation of the first operating element and reproduces the speech signal recorded by the first microphone by way of the first electroacoustic reproduction transducer, wherein reproduction of the audio signal to be reproduced is at least damped.

2. An earphone as set forth in claim 1 wherein the first control unit has a first active noise reduction unit and the second control unit has a second active noise reduction unit for respective active noise reduction.

3. A headset comprising:
a first housing with a first control unit, a first electroacoustic reproduction transducer, a first operating element and a first microphone for recording speech signals,
wherein the first control unit is electrically connected to the first operating element, the first microphone and the first electroacoustic reproduction transducer and receives an audio signal to be reproduced and outputs same in a first operating mode to the first electroacoustic reproduction transducer for reproduction, and
a second housing with a second control unit and a second electroacoustic reproduction transducer, wherein the second control unit receives an audio signal to be reproduced and outputs the audio signal for reproduction to the second electroacoustic reproduction transducer,
characterised in that at least the first control unit is switched into a second mode of operation upon actuation of the first operating element and reproduces the speech signal recorded by the first microphone by way of the first electroacoustic reproduction transducer, wherein reproduction of the audio signal to be reproduced is at least damped.

4. A method of controlling an earphone or a headset comprising the steps:
in a first operating mode reproduction of an audio signal by way of a first and/or second electroacoustic reproduction transducer and
in a second operating mode upon actuation of a first operating element reproduction of a speech signal by way of the first electroacoustic reproduction transducer and at least partial damping of the reproduction of the audio signal.

5. A headset comprising
a first housing with a first electroacoustic reproduction transducer,
a second housing with a second electroacoustic reproduction transducer,
at least a first control unit, and
a first operating element and at least a first microphone for recording speech signals,
wherein the at least one first control unit receives an audio signal to be reproduced and outputs the audio signal to be reproduced in a first operating mode to the first and/or second electroacoustic reproduction transducer for reproduction, wherein upon actuation of the first operating element the at least one first control unit is switched into a second operating mode and reproduces the speech signal recorded by the at least one first microphone by way of the first electroacoustic reproduction transducer,
wherein reproduction of the audio signal to be reproduced is at least damped by the first and/or second electroacoustic reproduction transducer.
